(19) United States
(12) Patent Application Publication
(10) Pub. No.: US 2013/0036684 A1
(43) Pub. Date: Feb. 14, 2013

(54) Wind Power Turbine System

(71) Applicant: KEMAH POWER LLC, Lake Barrington, IL (US)

(72) Inventors: Gregory C. Schmitt, Lake Barrington, IL (US); Konrad I. Osterhues, Lake Barrington, IL (US)

(73) Assignee: KEMAH POWER LLC, Lake Barrington, IL (US)

(21) Appl. No.: 13/651,609

(22) Filed: Oct. 15, 2012

Related U.S. Application Data
(62) Division of application No. 12/720,377, filed on Mar. 9, 2010.
(60) Provisional application No. 61/160,227, filed on Mar. 13, 2009.
(60) Provisional application No. 61/180,513, filed on May 22, 2009.

(51) Int. Cl. F03D 11/04; E04D 13/18; E04B 1/38

(52) U.S. Cl. 52/173.1; 52/745.21

(57) ABSTRACT

A method and system for mounting a horizontal-axis wind turbine to a building, stadiums and the like, is disclosed. The method and system generally include identifying a building structured to create the necessary air pressure gradient for supporting and operating a wind turbine, mounting the wind turbine in an optimal location on the rooftop, and permitting the wind turbine to operate. The generated electricity is collected and used in the building, either for tenant use or building operations.

### CROSS-REFERENCE TO RELATED APPLICATIONS

This application is a divisional application of U.S. patent application Ser. No. 12/720,377, titled “Vertical-Axis Wind Power Turbine System” and filed on Mar. 9, 2010, which claims the benefit of U.S. Provisional Application Nos. 61/160,227, filed on Mar. 13, 2009, and 61/180,513, filed on Mar. 22, 2009. Each of these prior applications is herein incorporated by reference.

Further, the following references are also incorporated herein by reference: U.S. Pat. No. 5,419,683 to Peace (May 30, 1995), U.S. Pat. No. 6,157,088 to Bendix (Dec. 5, 2000), and U.S. Pat. No. 7,276,808 to Weitkamp et al. (Oct. 2, 2007); and, U.S. Publication Nos. 2005/0121214 to Gould (Jun. 9, 2005), 2005/0230980 to Brunet (Oct. 20, 2005), 2006/0043737 to Ashikian (Mar. 2, 2006), 2006/0198724 to Bertony (Sep. 7, 2006), and 2008/0067816 to Garzmann (Mar. 20, 2008). These patents and publications form part of the disclosure of the present invention.

### TECHNICAL FIELD

The present invention relates generally to mounting wind turbines to preexisting structures, such as office and residential buildings, and the like. In particular, the present invention relates to mounting horizontal-axis wind turbines to such preexisting structures.

### BACKGROUND OF THE INVENTION

The commitment to make better use of renewable, non-polluting energy sources is an item on the agenda of many countries and businesses. Wind energy is a popular source explored by many not just because it fits the requirements of being renewable and non-polluting, but also because it is free. The downside to wind energy is that an infrastructure does not currently exist. Wind farms with acres of large wind-turbines have proved successful, but are generally a rural phenomenon. A broader, more geographically universal wind turbine construction and management approach is required to bring wind energy to its full potential.

Residential and office buildings are particularly suited for taking advantage of the benefits offered by wind turbines. These building may have numerous inhabitants with countless power demands. As winds blow into and across such a building, a low pressure is created at the top, while a high-pressure exists along the lee-side of the building. This pressure differential, even in low winds, can create a consistent wind source for a properly placed wind turbine. The power generated from several turbines can be used by the building inhabitants to meet at least some of the power demands. Further, some of these buildings may already have power transmission capabilities from existing emergency power generators or the like.

By identifying such structures as potential turbine sites, the present invention solves the long-standing problem of providing structural infrastructure for modern wind turbines. Where demand for power is greatest, the availability of existing structures is also high. Accordingly, the invention maximizes the potential of a green-energy source while simultaneously minimizing both the environmental impact and the economic investment.

### SUMMARY OF THE INVENTION

A wind driven power generating method and system are disclosed herein. The disclosed method and system improve upon the present state of the technology by adapting to and overcoming deficiencies in the prior art.

Generally speaking, the present inventive method and system comprise identifying an existing structure having a capability of supporting a wind turbine above the surface of the earth, mounting a vertical-axis wind turbine to the existing structure, connecting a power generator to the turbine, and permitting the wind turbine to operate. It is understood that the mounting of the turbine to the existing structure is done so as to avoid interference with normal operation of the existing structure and the wind turbine. Also, the generator is connected to the wind turbine in a manner which produces electricity as a result of the turning of the wind turbine.

In certain embodiments the method further comprises supporting the mounted turbine on the existing structure using additional supports. The existing structure may include a component which operates on electricity, such as a light, timer, or a motor, and the generated electricity may be used to power the component of the existing structure.

In various embodiments, the existing structure is one of either a transmission tower, a monopole tower, a billboard, a road sign, a street light, a utility pole, or a similar structure. In several embodiments, the use of a transmission tower is preferred because of the numerous mounting positions available on a lattice tower.

These and other aspects of the invention may be understood more readily from the following description and the appended drawings.

### BRIEF DESCRIPTION OF THE DRAWINGS

The invention may be better understood with reference to the following drawings. The components in the drawings are not necessarily to scale, emphasis instead being placed upon illustrating the principles of the invention. In the drawings, like reference numbers designate corresponding parts throughout.

FIG. 1 is a side view of a conventional vertical-axis wind power turbine having rotor blades, and a main rotor shaft that runs vertically;

FIG. 2A is a schematic view of a conventional preexisting lattice structured transmission tower;

FIG. 2B is a schematic view of a vertical-axis wind power turbine mounted inside of the lattice structured transmission tower of FIG. 2A;

FIG. 2C is a schematic view of a vertical-axis wind power turbine attached at its base to the lattice structured transmission tower of FIG. 2A;

FIG. 2D is a schematic view of a vertical-axis wind power turbine attached at both its base and top to the lattice structured transmission tower of FIG. 2A;

FIG. 2E is a schematic view of a vertical-axis wind power turbine attached, at its base, to the ground and vertically extending within the lattice structure of the transmission tower of FIG. 2A;

FIG. 2F is similar to FIG. 2E, but with a plurality of vertical-axis power turbines also attached to the outer periphery of the lattice structured transmission tower;

FIG. 2G is a simplified plan view of the embodiment of FIG. 2F taken along plane 2G-2G of FIG. 2F;

FIG. 2H is a plan view similar to FIG. 2G, but with the vertical-axis power turbines attached to the outer periphery of the lattice structured transmission tower in another configuration in accordance with the present invention;

FIG. 3A is a schematic view of a vertical-axis wind power turbine mounted on the supporting arm portion of the lattice structured transmission tower of FIG. 2A;

FIG. 3B is similar to FIG. 3A, but with the vertical-axis wind power turbine attached at both its base and top to the lattice structured transmission tower;

FIG. 4 is a schematic view of a vertical-axis wind power turbine mounted on a supporting arm portion of a conventional preexisting monopole structured tower;

FIG. 5A is a schematic view of a vertical-axis wind power turbine mounted to an upper portion of a conventional preexisting billboard sign;

FIG. 5B is similar to FIG. 5A, but with a plurality of vertical-axis wind power turbines also mounted to the billboard sign and the monopole supporting the bill board sign;

FIG. 6 is a schematic view of a vertical-axis wind power turbine mounted atop a conventional preexisting traffic signal;

FIG. 7 is a schematic view of a vertical-axis wind power turbine mounted atop a conventional preexisting road sign;

FIG. 8 is a schematic view of a vertical-axis wind power turbine mounted to an upper portion of a conventional preexisting water tower;

FIG. 9 is a partial elevation view of a pair of vertical-axis wind power turbines mounted to a portion of a conventional preexisting pole;

FIG. 10 is a simplified partial plan view of three vertical-axis wind power turbines mounted to a portion of a conventional preexisting pole;

FIG. 11 is a simplified schematic view of a vertical-axis wind power turbine erected next to a conventional cell phone tower;

FIG. 12 is a simplified schematic view of a vertical-axis wind power turbine mounted to a portion of a conventional pole for street lights and parking lot lights;

FIG. 13 is a partial elevation view of a vertical-axis wind power turbine with a plurality of blades modified to utilize aerodynamic drags to convert wind energy into mechanical energy; and,

FIG. 14 is a schematic view of a horizontal-axis wind power turbine erected on top of a building.

### DETAILED DESCRIPTION OF THE INVENTION

While this invention is susceptible of embodiments in many different forms, there is shown in the drawings and will herein be described in detail a preferred embodiment of the invention with the understanding that the present disclosure is to be considered as an exemplification of the principles of the invention and is not intended to limit the broad aspect of the invention to embodiments illustrated.

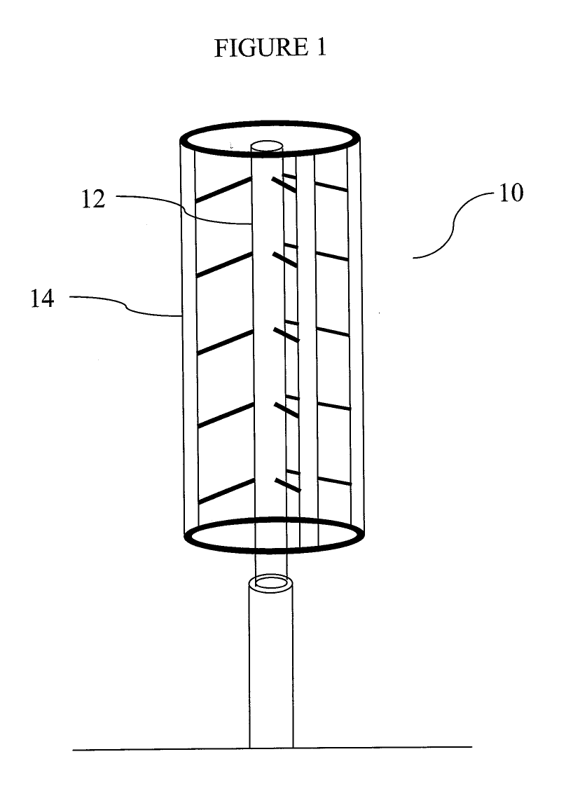

Referring to FIGS. 1-14, there are illustrated several embodiments of a vertical-axis wind turbine or VAWT, generally designated by the numeral 10. Such turbines are sold, for example, by Mariah Power, 5470 Louie Ln., Suite 104, Reno, Nev. under the mark WNDSPIRE® (see also http://www.mariahpower.com). However, the invention disclosed herein is not intended to be limited to a single type of VAWT such as that shown in the appended drawing figures or as sold by Mariah Power.

As shown in FIG. 1, the VAWT 10 has a main rotor shaft 12 that runs vertically along the longitudinal axis of the VAWT. As also shown in FIG. 1, the illustrated VAWT 10 is a Darrieus wind turbine having multiple rotor blades (airfoils) 14, which make the VAWT 10 resemble an eggbeater. A preferred embodiment of the VAWT 10 is built with three blades 14, but other embodiments may include more than three blades.

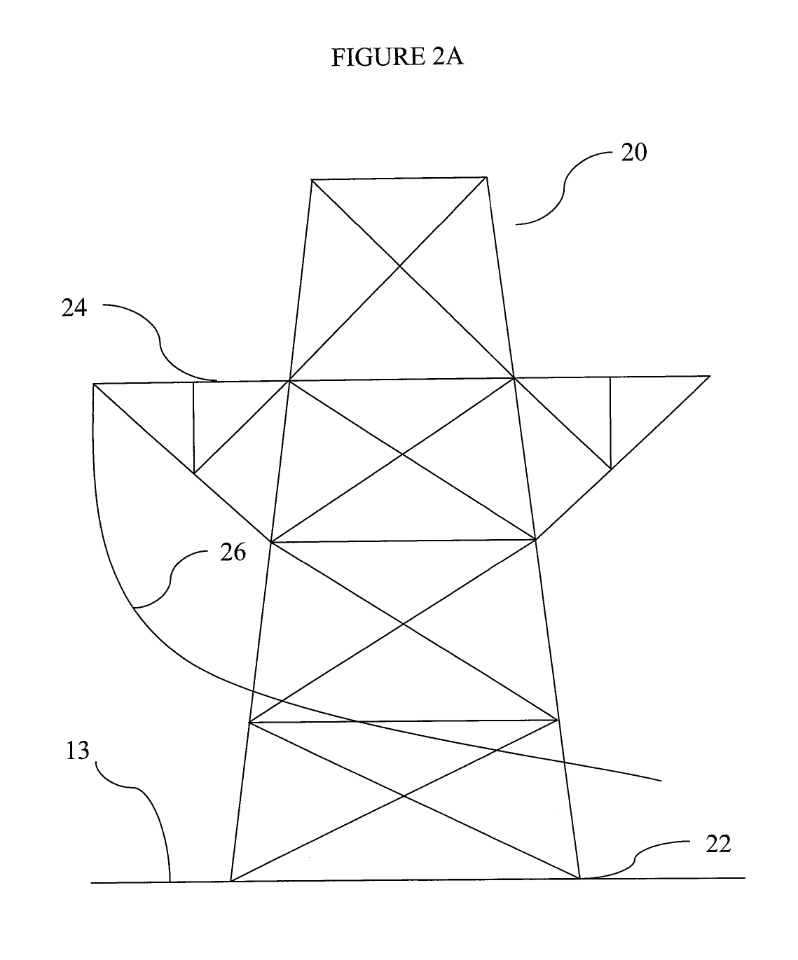

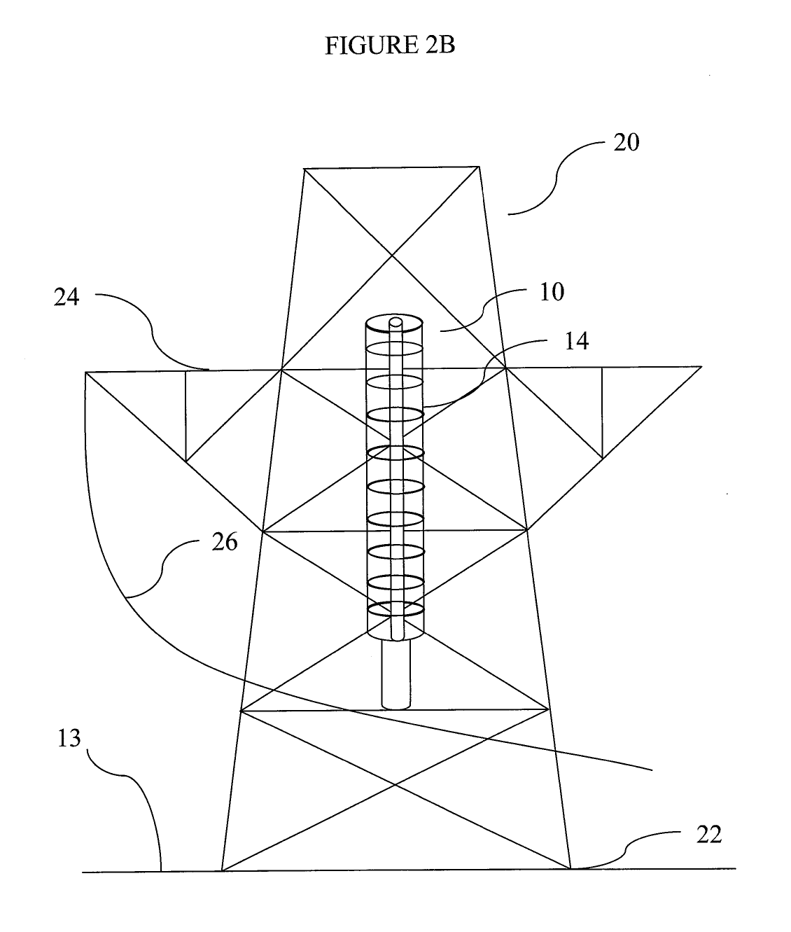

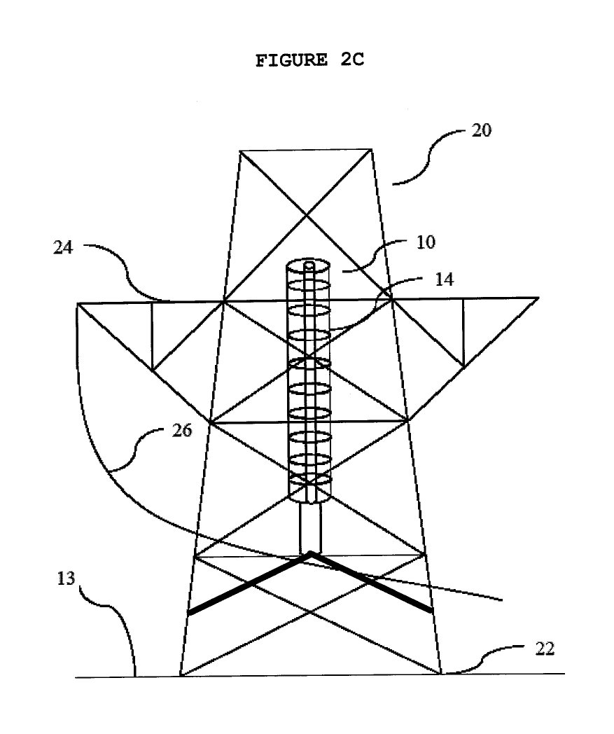

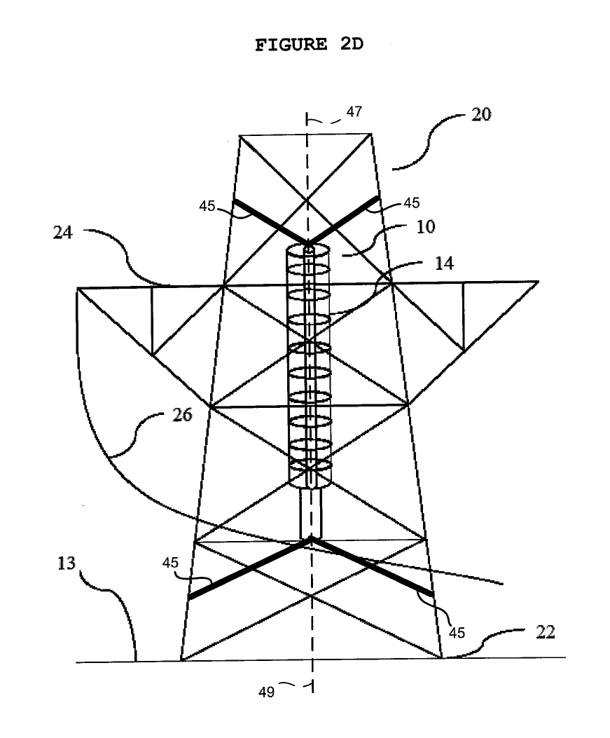

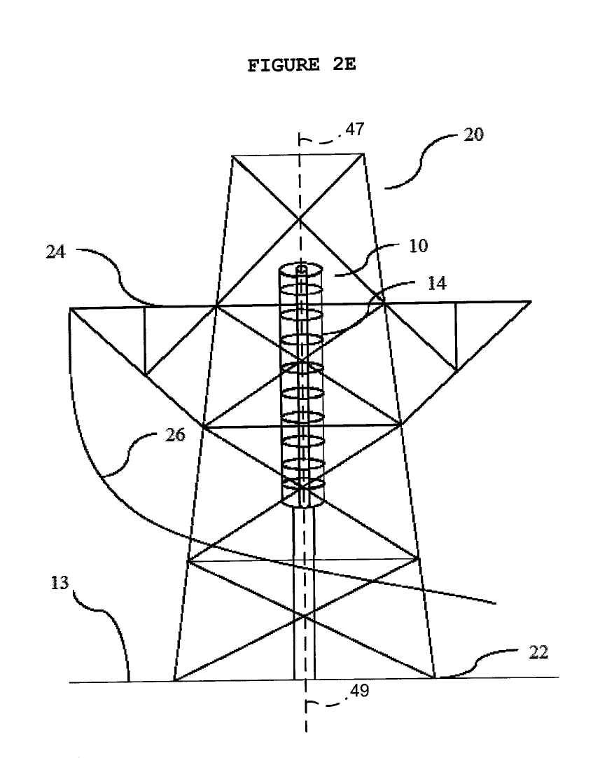

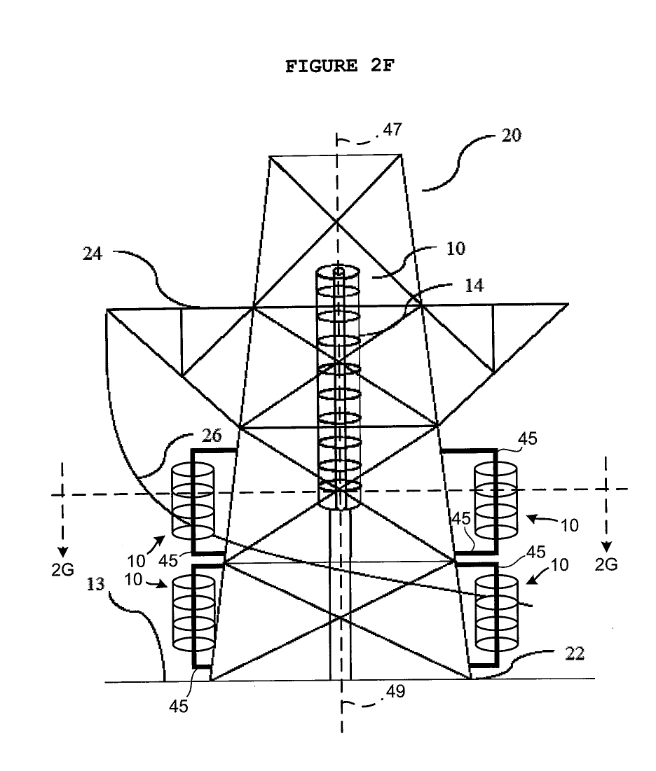

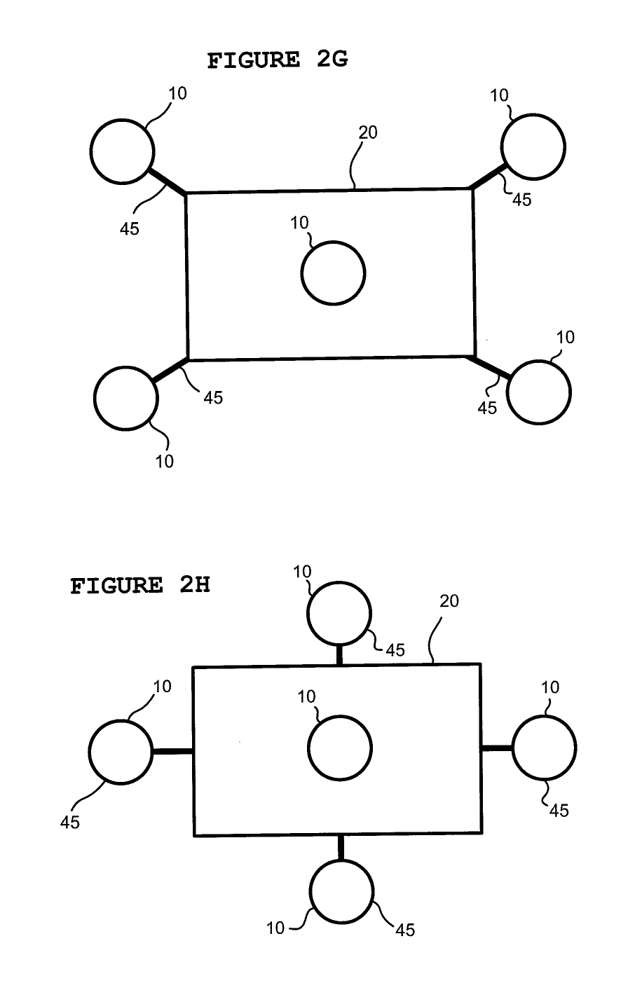

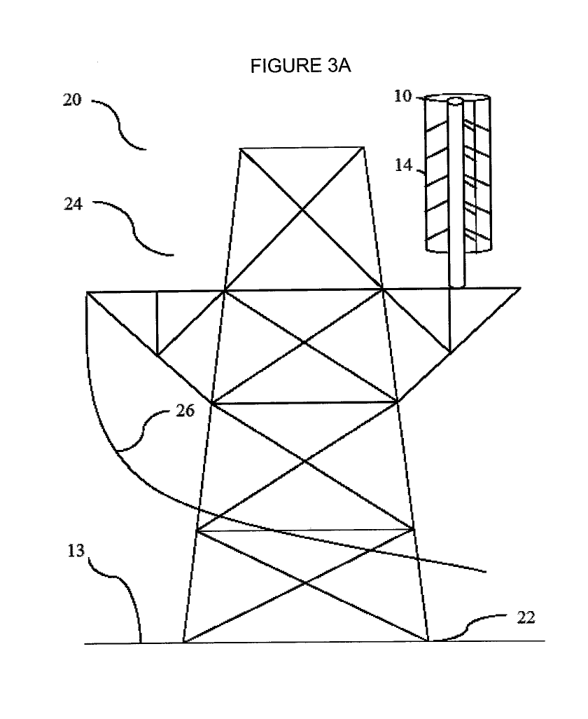

FIG. 2A shows a conventional lattice structured power transmission tower 20. The tower structure 20 has a base 22 anchored to the ground 13 and a plurality of supporting arms 24 for supporting power lines 26 that transmit electric power. As shown in FIG. 2B, a VAWT 10 is mounted inside of the transmission tower 20 in such a manner that there is sufficient clearance inside of the transmission tower 20 for the rotor blades 14 to rotate about the longitudinal axis of the VAWT. The power transmission tower 20 preferably employs a lattice tower structure to provide stability due to the extra load exerted on the power transmission tower. Although the VAWT 10 is mounted preferably inside the preexisting transmission tower 20, the VAWT 10 need not be mounted in that manner only. Indeed, the VAWT 10 may be mounted anywhere on the preexisting transmission tower 20, provided the rotor blades 14 do not interfere with the power lines.

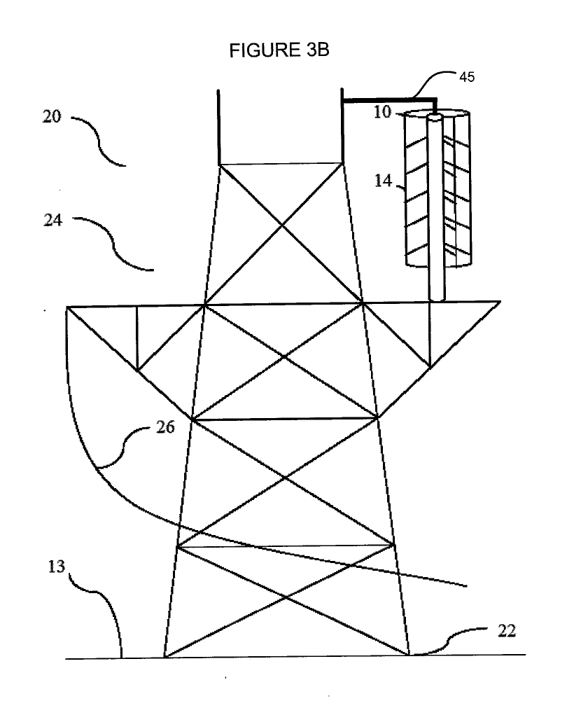

FIG. 3A is an example of an illustration where the VAWT 10 is mounted on the supporting arm 24 portion of the transmission tower 20. Further, FIG. 3B depicts a VAWT 10 that is attached at both its base and top, by additional support member(s) 45, to a preexisting lattice structured electrical transmission tower 20.

As shown in FIG. 2C, the VAWT 10 can be attached by its base to the transmission tower 20 by a frame consisting of one or more support members 45 wherein the frame is attached to the transmission tower 20 and the VAWT 10 by conventional means such as, but not limited to, the use of bolts, clamps or welds. Alternatively, as shown in FIG. 2D, the VAWT 10 can be attached at both its base and top by a pair of frames consisting of support member 47. In yet another embodiment, as shown in FIG. 2E, the base of the VAWT 10 can be mounted to the ground and vertically extend within the lattice structure of the transmission tower. In still yet another embodiment, the base of the VAWT can be mounted to the ground and vertically extend within the lattice structure of the transmission tower while the VAWT is also connected to the transmission tower by a frame. Preferably, but not necessarily, the longitudinal axis 47 of the VAWT is in coaxial alignment with the longitudinal axis 49 of the transmission tower.

Turning to FIG. 2E, a schematic view is provided of a VAWT 10 that is mounted at its base in a conventional manner to the ground 13 and vertically extends within the lattice structure of the transmission tower 20. FIG. 2F is similar to FIG. 2E, but with a plurality of VAWTs also attached to the outer periphery of the preexisting lattice structured transmission tower by support members 45. Moreover, FIG. 2G is a simplified plan view of the embodiment of FIG. 2F taken along plane 2G-2G of FIG. 2F, and FIG. 2H is a plan view similar to FIG. 2G, but with the VAWTs 10 attached, by support members 45, to the outer periphery of the lattice structured transmission tower 20 in another configuration.

FIGS. 3A and 3B illustrate additional alternative embodiments where the VAWT 10 is mounted outside the lattice structure of the transmission tower 20. In each embodiment the VAWT 10 is mounted on a supporting arm 24 of the transmission tower 20. FIG. 3B includes additional supports 45 to secure the VAWT 10 to the transmission tower frame. Though not illustrated, in other embodiments in accordance with the present invention, one or more VAWTs could be conventionally mounted on an easement generally underneath the electrical transmission lines extending from one transmission tower/structure to another.

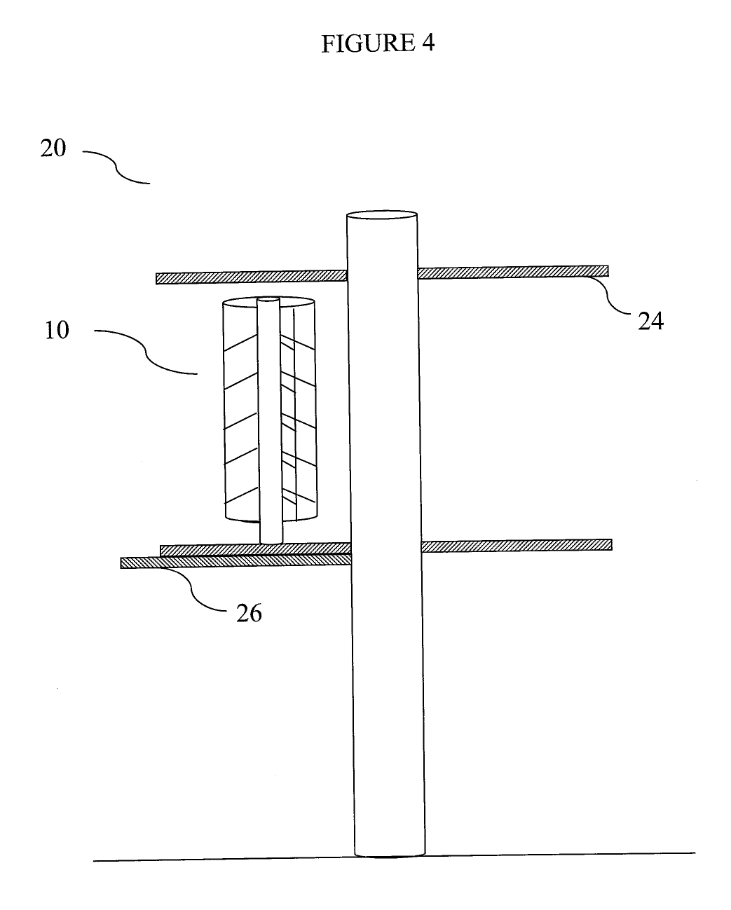

It is understood, as explained above, that the transmission tower 20 preferably has a lattice structure so that the VAWT 10 can be mounted inside of the lattice of the transmission tower 20. Alternatively, it is also contemplated that the transmission tower 20 could be a monopole structure, such as a utility pole as shown in FIG. 4. As further illustrated in FIG. 4, a VAWT 10 is mounted on the supporting arm 24 of a preexisting monopole structured transmission tower 20. It is understood that the supporting arm 24 of the monopole structured tower 20 is able to withstand the weight of the VAWT 10. Otherwise, an additional supporting base 26 can be constructed to ensure that the supporting arm 24 withstands the weight of the VAWT 10. Although FIG. 4 shows one VAWT 10 mounted to the supporting arm 24, it is also contemplated that more than one VAWT 10 can be mounted in a series along the supporting arm 24. Also, another VAWT 10 may be mounted at the top portion of the monopole 20, provided the monopole tower can withstand the weight of the VAWTs. While a monopole transmission tower is contemplated for this embodiment, the monopole tower such as a cell tower is also contemplated for mounting a VAWT 10.

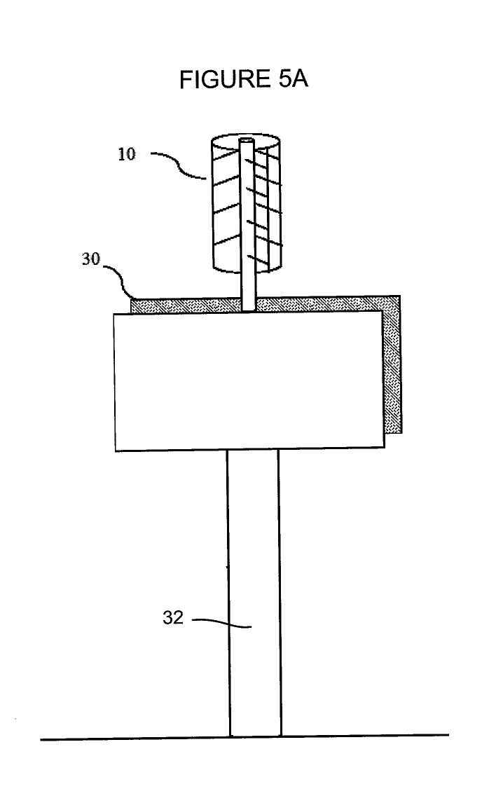

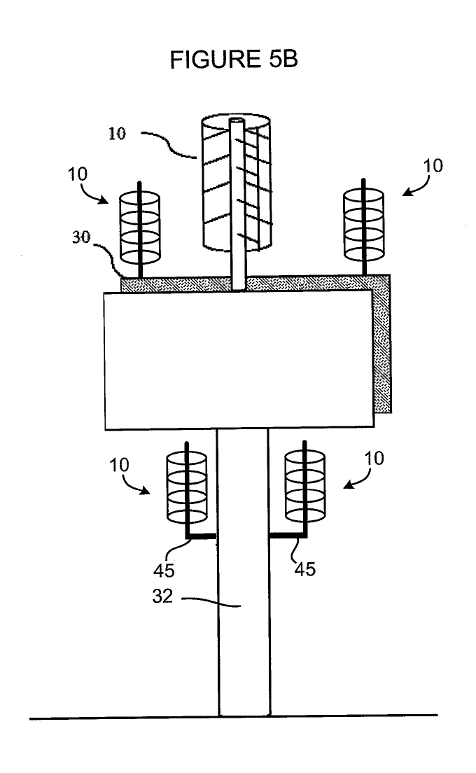

FIG. 5A illustrates another embodiment of the present invention wherein a VAWT 10 is mounted to an upper portion of a billboard sign 30. In this embodiment, the VAWT 10 is mounted to the monopole 32 that supports the billboard sign 30 such that the VAWT 10 is supported by the monopole, rather than the billboard sign 30. An extension pole 32 can be used to extend the monopole 34 supporting the billboard signs 30 so that the VAWT 10 can be mounted on top 36 so that the rotor blades 14 do not interfere with the actual bill board signs 30. Moreover, FIG. 5B is similar to FIG. 5A, but with additional VAWTs 10 mounted to the billboard sign 30 and the monopole 32 supporting the billboard sign. Accordingly, in an embodiment, VAWTs can be mounted almost anywhere to the billboard or the structure supporting the billboard, as long as such mounting would support the VAWT 10 thereto.

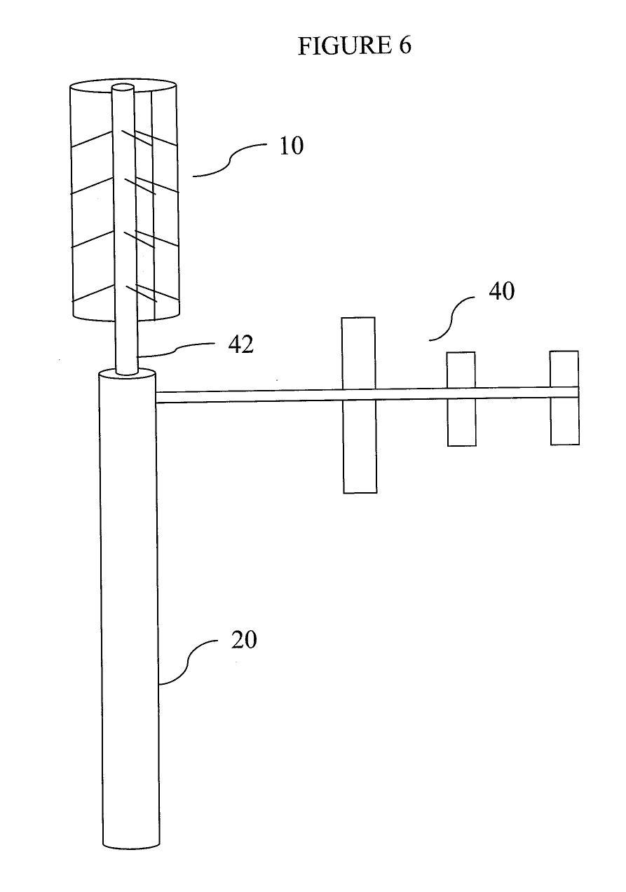

FIG. 6 shows yet another embodiment of the present invention wherein a VAWT 10 is mounted atop a monopole 20 supporting traffic signals 40. It is contemplated that the VAWT 10 is connected by an intermediate rod 42 to retain structural integrity and to provide stability.

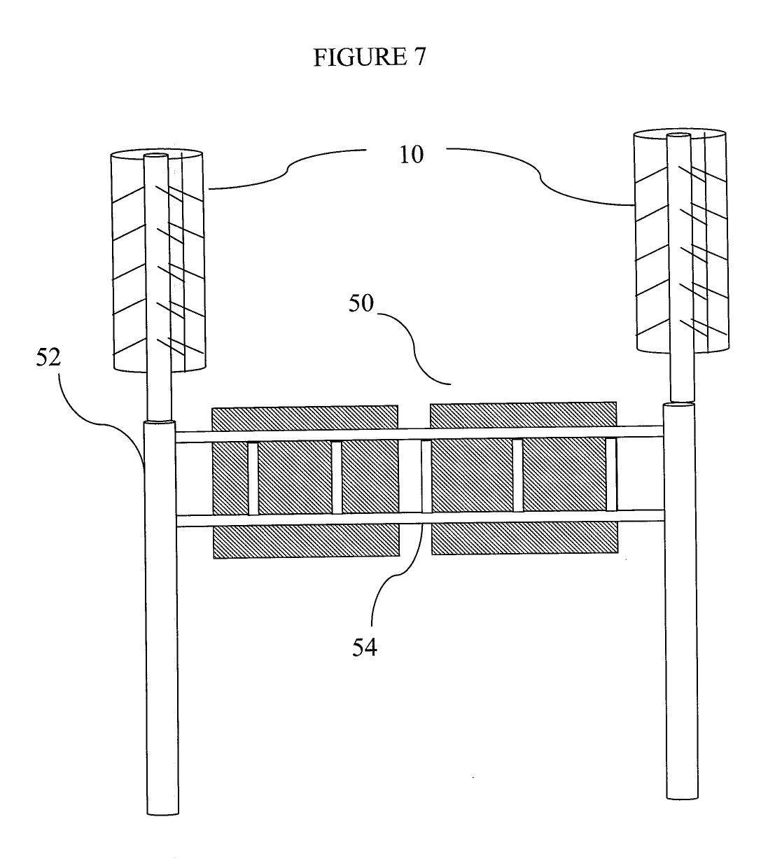

FIG. 7 illustrates another embodiment of the present invention wherein a VAWT 10 is mounted atop a road sign 50, such as a highway sign. As shown, the VAWT 10 is mounted on top of each of the support rods 52 so that more than one VAWT 10 can be mounted thereon. It is also contemplated, though not shown, that the VAWT 10 may be mounted on a crossbar 54 that supports the sign(s) 50 provided the crossbar 54 can withstand the additional load due to the VAWT 10. Similar to the embodiment depicted in FIG. 7, one or more VAWTs can be mounted to a railway gantry or signal bridge extending over one or more railroad tracks.

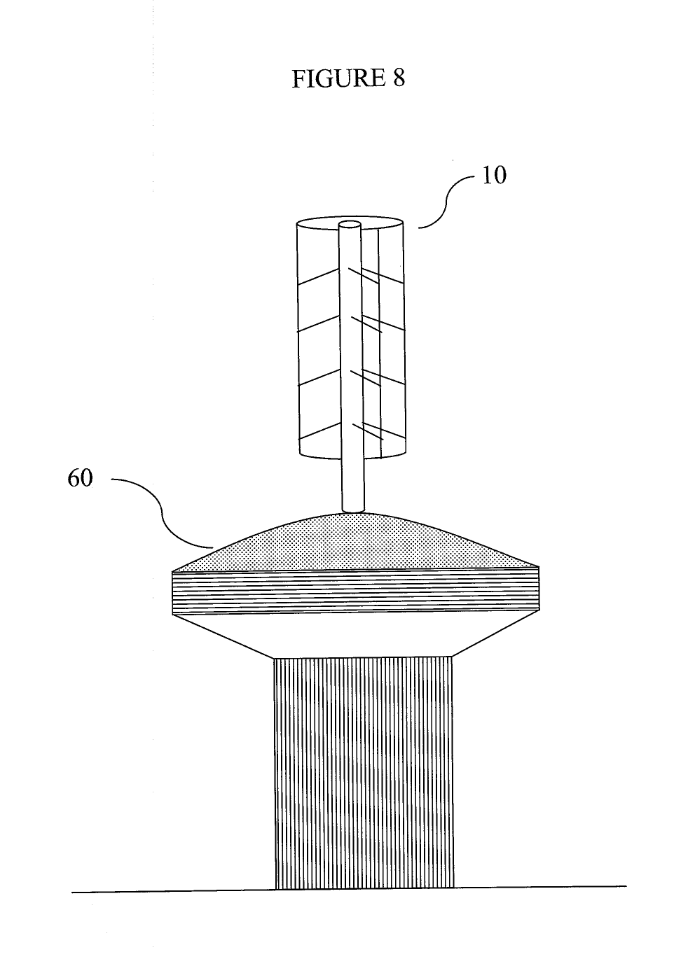

FIG. 8 illustrates another embodiment of the present invention wherein a VAWT 10 is mounted atop a water tower 60, a large elevated water storage container. The VAWT 10 may be mounted, as shown, at the apex of the tower 60, or it may be mounted along the periphery of the tank.

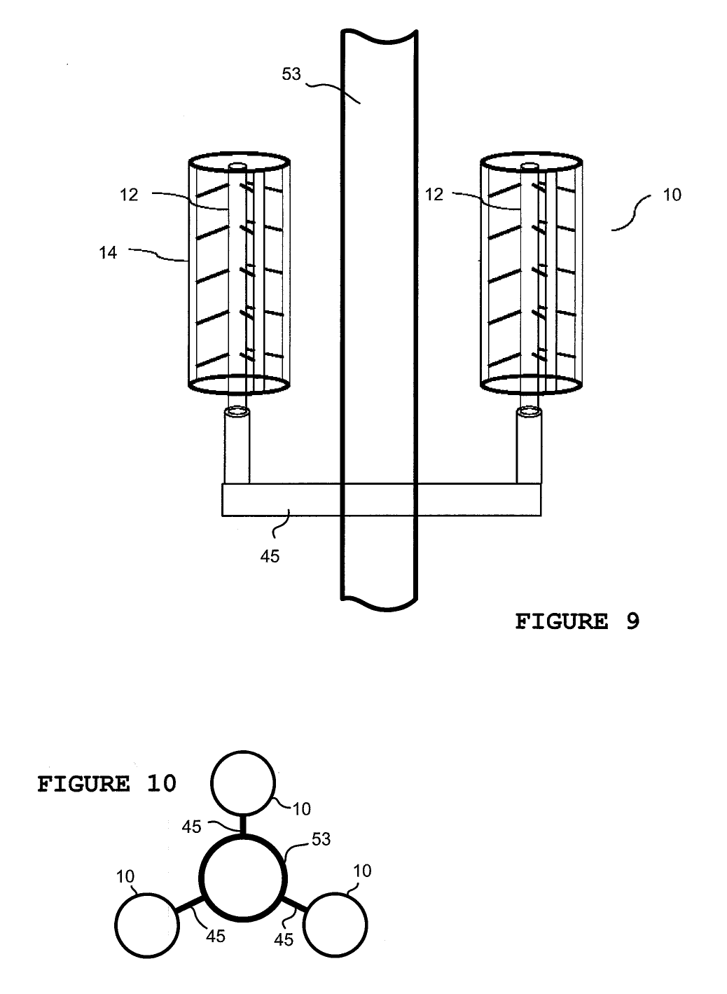

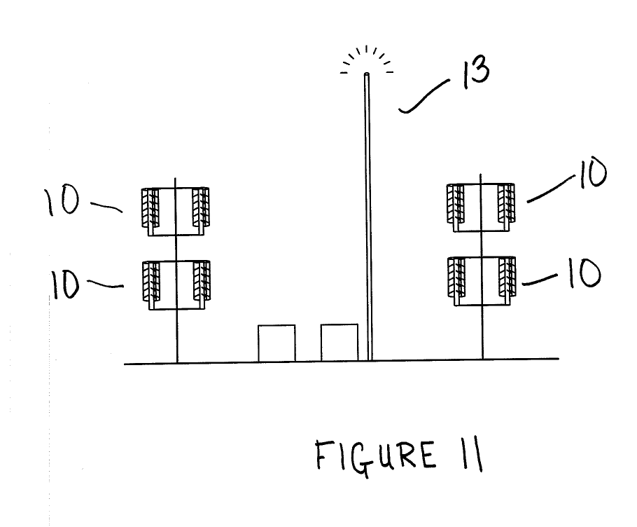

FIG. 9 provides a partial plan view of a pair of vertical-axis wind power turbines 10 mounted to a portion of a conventional preexisting pole 53. Preferably, but not necessarily, the turbines 10 are symmetrically mounted on each side of the pole 53 for added stability. For instance, if three turbines 10 are mounted to pole 53, then the turbines would be mounted in the triangular configuration depicted in FIG. 10, via equivalent members 45. If desired, additional support members could be mounted to the top of the VAWTs 10 for securing them to the pole.

FIG. 11 illustrates another embodiment of the present invention wherein a plurality of VAWTs 10 are mounted (in a manner similar to that depicted in FIGS. 9 or 10) to poles in proximity to a conventional cellular telephone base station tower 13. The electronics (not shown) for operating the cellular telephone base station tower could be powered, in part, by a power generator electrically coupled to the VAWTs 10. In turning, the VAWT conventionally converts the wind energy into mechanical energy which is then converted to electric energy through operation of the generator (or alternator, not shown). The electronics for operating the cellular telephone base station could also be powered, in part, by a battery and/or a gas or liquid fuel powered generator.

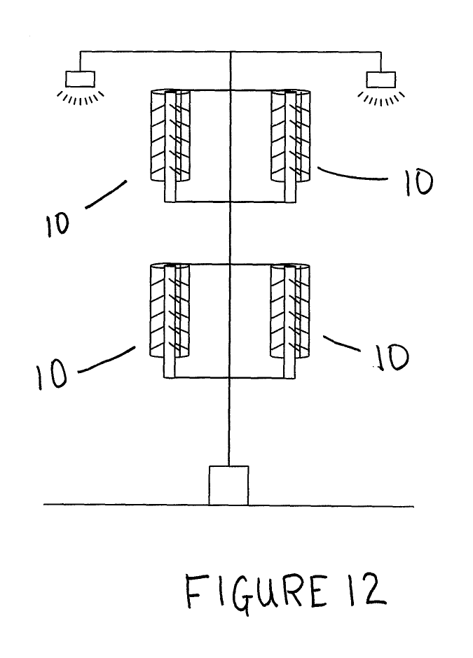

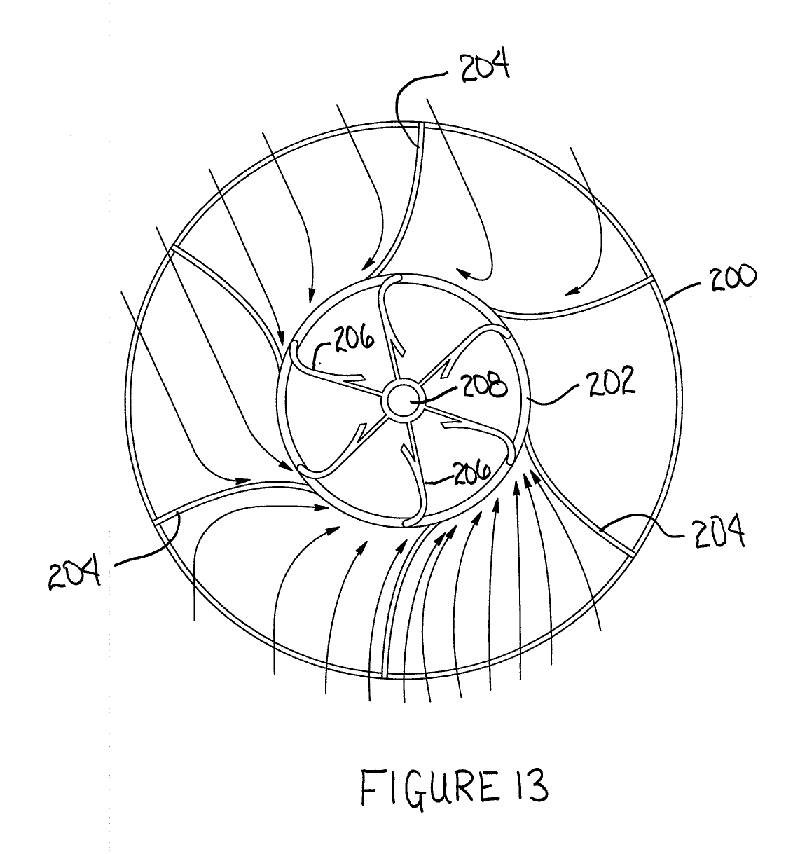

FIG. 12 illustrates yet another embodiment of the present invention wherein a plurality of VAWTs 10 are mounted on a pole(s) that also includes street lights and/or parking lot lights. As will be understood, the pole is able to support the VAWTs 10 that are attached thereto in a number of different configurations, including those depicted in FIGS. 9 and 10.

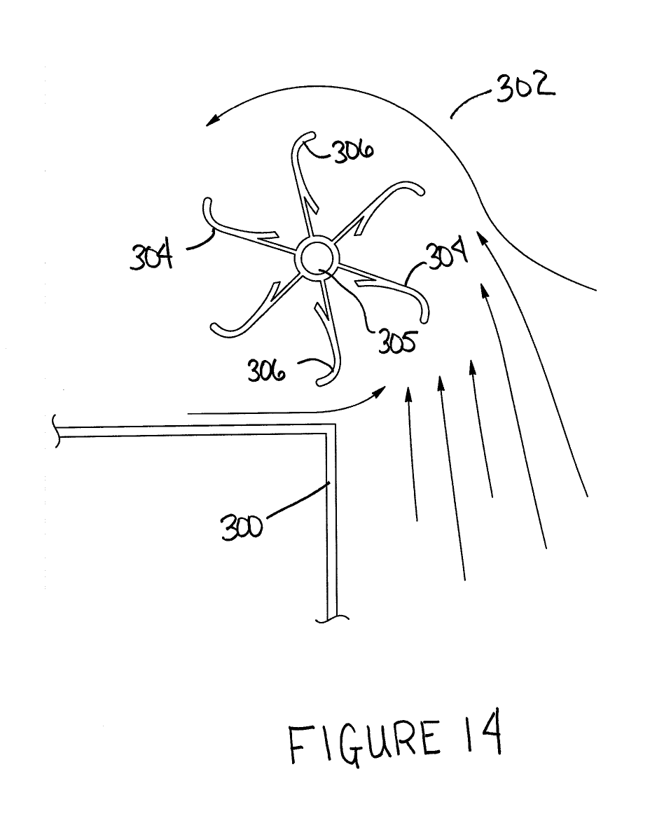

FIG. 13 is a partial plan view of an embodiment of a VAWT 10 which is capable of being mounted to a portion of a conventional pole. As shown in FIG. 13, the VAWT 10 includes a plurality of rotor blades 204 positioned between the inner ring 202 and the outer ring 200 and extending in its entirety from the top to the bottom of the turbine 10. While six blades 204 are shown in FIG. 13, a person of ordinary skill in the art will appreciate that more or fewer blades can be used for the purpose of the present invention. Each rotor blade 204 is configured in a way so that the inner portion of the blade is in contact with the inner ring 202 and each blade 204 is curved to utilize aerodynamic drag and thereby induce torque upon the rotor. Smaller blades 206 are positioned between the rotor shaft 208 and the inner ring 202. As can be seen, these smaller blades 206 are curved at their ends in contact with the inner ring 202 and in a direction opposite the curvature of the outer blades 204. This configuration provides optimal performance of the VAWT 10 while in use.

FIG. 14 is a schematic view of an embodiment of the present invention, illustrating a horizontal-axis wind power turbine 302 mounted on top of a building 300 to utilize winds blowing against the building 300. When winds, particularly high winds, blow against a building, it creates a high pressure on the side of the building and a low pressure on the top/roof of the building. This creates a pressure differential significant enough in certain environmental conditions such that wind power turbine systems mounted on building roofs are effective at converting wind power to mechanical energy. To take full advantage of this scenario, as shown in FIG. 14, the wind power turbine 302 is mounted horizontally with a plurality of blades 304 extending from the rotor shaft 305. At the end section of each blade, a semi-circular airfoil 306 is attached to the blade 304, so that as the high-pressure air flows upward along the side of the building 300 toward the low-pressure air, the semi-circular airfoils 306 induce torque upon the rotor 305 to generate mechanical energy.

In each embodiment described above, surplus electrical power generated by the generator (or alternator) coupled to the VAWT can be supplied, by conventional means, to electrical transmission cables running to the structure. For instance, in the embodiments of FIGS. 2B-2E and 3, the surplus electrical power generated by the VAWT(s) can be supplied to electrical transmission cables running to the transmission tower. Likewise, the surplus electrical power from the VAWT(s) can be supplied to the electrical transmission cables provided to the monopole structure of FIG. 4, the billboard structure of FIG. 5, the traffic signal structure of FIG. 6, the road sign structure of FIG. 7, the water tower structure of FIG. 8, the poles of FIGS. 9 and 10, the cell phone tower of FIG. 11, the street lights and parking lot lights of FIG. 12, or the like. In each case, the electrical energy generated can be used to power some component of the structure, such as lights, timers, a motor

It should be emphasized that the above-described embodiments of the present invention, particularly, any “preferred” embodiments, are possible examples of implementations merely set forth for a clear understanding of the principles for the invention. Many variations and modifications may be made to the above-described embodiment(s) of the invention without substantially departing from the spirit and principles of the invention. All such modifications are intended to be included herein within the scope of this disclosure and the present invention, and protected by the following claims. For instance, one or more VAWTs can be installed about the top upper perimeter of a football stadium or other large outdoor public venue.

What is claimed is:

1. A method for constructing a wind turbine power plant comprising the steps of:
positioning a horizontal-axis wind turbine along a rooftop of a building so as to take advantage of a pressure gradient air flow;
determining an optimum position for the wind turbine along the rooftop;
mounting the wind turbine at the determined position on the rooftop;
connecting a power generator to the wind turbine in a manner which produces electricity as a result of the turning of the wind turbine;
permitting the wind turbine to operate;
collecting electricity generated as a result of the operation of the wind turbine; and
using the collected electricity in the building.

2. The method of claim 1, wherein the horizontal-axis wind turbine is movable along an edge of the rooftop.

3. The method of claim 1, wherein the wind turbine is mounted to extend beyond an edge of the rooftop.

4. The method of claim 3, wherein the wind turbine comprises a plurality of blades connected to a rotor shaft and the plurality of blades extend beyond the edge of the rooftop.

5. The method of claim 4, wherein the wind turbine further comprises a semi-circular air-foil attached to an end section of each blade.

6. The method of claim 1, further comprising the steps of mounting at least one additional horizontal-axis wind turbine on the building rooftop and coupling the additional wind turbine to an additional generator such that electricity is produced as a result of the turning of the at least one additional wind turbine.

7. A wind power plant system comprising:
a building having a suitable structure for creating a low-pressure area proximate a rooftop relative to an area along the building below the roof;
a horizontal-axis wind turbine mounted on the building within the low-pressure area; and
a generator coupled to the wind turbine in a manner which produces electricity upon operation of the turbine.

8. The wind power plant system of claim 7, wherein the horizontal-axis wind turbine is mounted on the building along an edge of the rooftop.

9. The wind power plant system of claim 8, wherein the horizontal-axis wind turbine is movable along the edge of the rooftop.

10. The wind power plant system of claim 9, wherein the wind turbine is further mounted to extend beyond the edge of the rooftop.

11. The wind power plant system of claim 7, wherein the wind turbine comprises a plurality of blades connected to a rotor shaft.

12. The wind power plant system of claim 11, wherein the wind turbine further comprises a semi-circular airfoil attached to an end section of each blade.
